(19) United States
(12) Patent Application Publication
(10) Pub. No.: US 2007/0212664 A1
(43) Pub. Date: Sep. 13, 2007

(54) Dental model

(76) Inventor: Gerd Oestreich, San Diego (SV)

Correspondence Address: Mark P. Stone, 4th Floor, 25 Third Street, Stamford, CT, 06905, US

(21) Appl. No.: 11/715,290

(22) Filed: Mar. 7, 2007

(30) Foreign Application Priority Data
Mar. 9, 2006 (DE) 10 2006 012 124.4

(51) Int. Cl. A61C 11/00

(52) U.S. Cl. 433/213

(57) ABSTRACT

The invention relates to a dental model with a base body (1) that has an essentially U-shaped dental arch (2) on its upper side. The side ridges of the dental arch (2) and/or its front ridge are or is provided with at least one dental work (4) for demonstration purposes. In order to facilitate presentations of a larger number of dental works than allowed in the dental models known until now without significantly changing the outer appearance of the model, the invention provides for the base body (1) also to have an essentially U-shaped dental arch (3) on its underside. The side ridges and/or front ridge of the U-shaped dental arch are or is likewise provided with at least one dental work (6) for demonstration purposes. Furthermore, the base body (1) is held in a supporting frame (8) in such a way that it can rotate. An upper edge (15) of the supporting frame (8) lies flush against the circumference of the base body (1) in two demonstration positions.

### BACKGROUND OF THE INVENTION

The invention relates to a dental model with a base body that, on its upper side, has an essentially U-shaped dental arch whose side ridges and/or front ridge are or is provided with at least one dental work for demonstration purposes.

Dental models of the preceding type are known in various embodiments, e.g., from WO 84/03978, EP 0 253 757 B1 and U.S. Pat. No. 3,478,428. In all of the known models, it is possible to mount dental works on one of the dental arches, one at a time. It is understood that, particularly in the case of discussions between the doctor and patient, there is considerable interest in providing the patient with comprehensive advice while demonstrating as many alternatives as possible to the patient. The same holds true for teaching and continuing education events. Because in practice, a dental arch offers room for only a limited number of dental works, EP 0 253 757 B1 already suggests that a portion of the dental arch be equipped with a turning insert piece, which is provided with various dental works. In the last-mentioned case, however, a certain impairment of the appearance of either the gum or floor of the mouth of the model surrounded by the dental arch must be accepted.

### SUMMARY OF THE INVENTION

The object of the invention is to create a dental model that allows the presentation of a larger number of dental works than do dental models known as of this time, without the outer appearance of the model showing significant deviations from known models with regard to its shape and size. The above object is solved in accordance with the invention in that the base body, for demonstration purposes, also has on its underside an essentially U-shaped dental arch, whose side ridges and/or front ridge are or is also provided with at least one dental work, in that the base body is held in a supporting frame in a manner that allows it to turn and in that the upper edge of the supporting frame lies flush against the circumference of the base body in two demonstration positions, which are defined by latching elements.

The dental model according to the invention offers not only the advantage that more dental works can be presented with its help than with the models known hitherto, but additionally prevents impairments of the appearance of the roof of the mouth and the floor of the mouth of the model, whereby these impairments, which are necessitated by the design of the solution disclosed in EP 0 253 757 B1, are caused by disturbing open sections or gaps. Naturally, with the new model, it is also possible to connect all dental works to the dental arch in such a way that they are interchangeable.

### BRIEF DESCRIPTION OF THE DRAWINGS

Further features and details of the invention follow from the dependent claims and the attached drawings and from their subsequent description. Shown are:

FIG. 1 a perspective view of the base body, held in its supporting frame, in one of the two possible demonstration positions

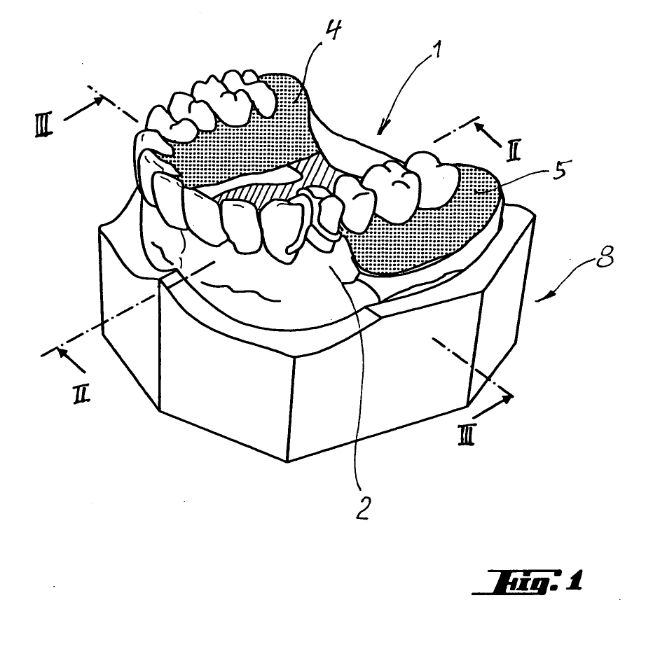

FIG. 2 a partial section along the line II-II in FIG. 1 and

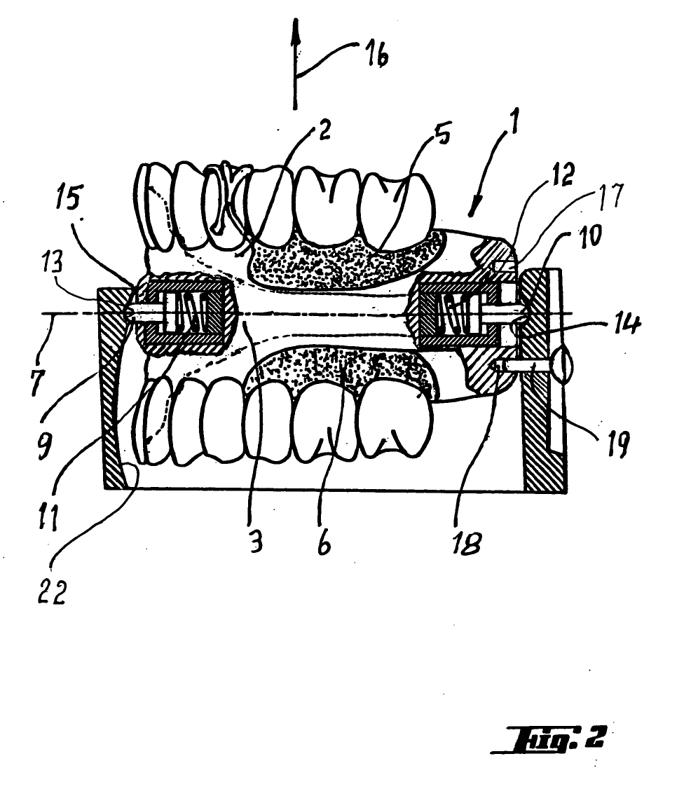

FIG. 3 a partial section along the line III-III from FIG. 1.

### BEST MODES FOR CARRYING OUT THE INVENTION

In the figures, 1 is the base body, which has two essentially U-shaped dental arches 2 and 3, one on each of two opposing sides. The dental arches 2, 3 are equipped with interchangeable dental works 4, 5 and 6, two of which are attached to the upper side of the base body 1 in a known manner, and one of which is attached to the underside of the base body 1 in a known manner. The base body 1 is held, in a manner such that it can be rotated around an axis, in an essentially ring-shaped supporting frame 8, which is open at the top and bottom. For holding the base body 1 in this case, two aligned tabs 9 and 10 are provided, which are pressed by springs 11 and 12 into flat cavities 13 and 14. The sections of the cavities 13, 14 aimed at the upper edge 15 of the supporting frame 8 form ramps with an angle of inclination which moves the tabs 9 and 10 out of the cavities 13, 14 against the effect of the springs 11, 12 when a force is exerted on the base body 1 in the direction of the arrow 16.

In order to hold the base body 1 in a particular demonstration position, the model has, arranged at the back end of the base body 1, bore holes 17, 18, into which a latching pin 19 can be slid. Instead of the latching pin 19, a rubber plug or a ball, loaded by a spring and held in a cylindrical chamber in such a manner that it cannot be lost, can be used, whereby the plug or ball snaps into place in cavity.

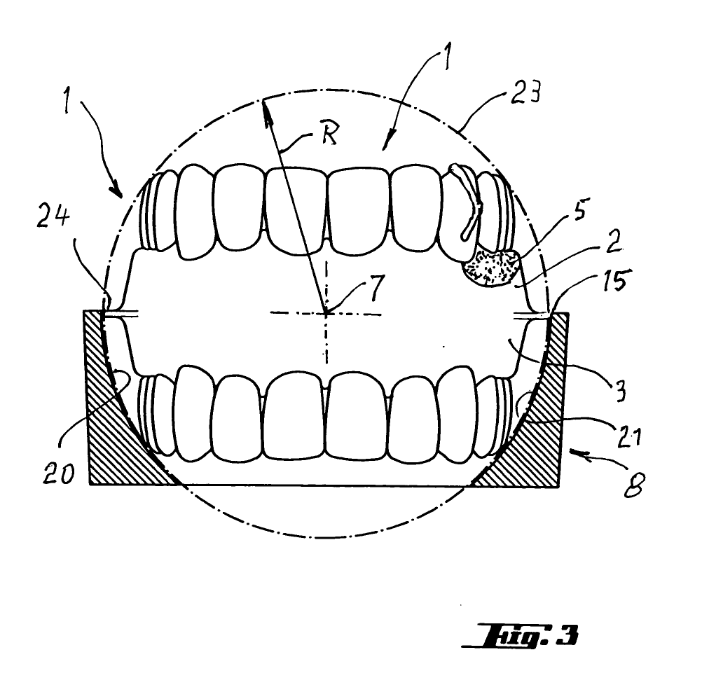

In order to allow the base body 1 to turn without obstruction, at least parts 20, 21 and 22 of the inner wall of the supporting frame 8 have a curvature with a radius of curvature R, which corresponds to the radius R of the enveloping circle 23, shown in FIG. 3, that encloses the base body 1.

From FIG. 3, it can also be seen that the upper edge 15 of the supporting frame 8 lies practically flush against the upper edge 24 of the base body 1, i.e., that there is only a minimum gap, which forms a joint or juncture, between the two edges 15 and 24.

Naturally, the described model can be used to present not only pathologically related dental works, so that it is also easily possible to portray medical conditions or cosmetic design possibilities using the model. Because of its compactness and versatility, it is particularly suitable for use in lectures and speaking events.

1. Dental model with a base body (1) that has on its upper side an essentially U-shaped dental arch (2), whose side ridges and/or front ridge are or is, for demonstration purposes, provided with at least one dental work (4), characterised in that the base body (1) also has, on its underside, an essentially U-shaped dental arch (3), whose side ridges and/or front arch are or is, for demonstration purposes, likewise provided with at least one dental work (6), in that the base body (1) is held in a support frame (8) in such a way that it can be turned, and in that the upper edge (15) of the supporting frame (8) lies flush against the circumference of the base body (1) in two demonstration positions.

2. Dental model according to claim 1, characterised in that the base body (1) can be rotated around an axis (7) that runs parallel to the longitudinal axis of the roof of the mouth or floor of the mouth of the model.

3. Dental model according to claim 2, characterised in that the axis of rotation (7) of the base body (1) is formed by two aligned tabs (9, 10), whose round ends jut into flat cavities (13, 14) of the supporting frame (8) and at least one of which is pressed by a spring (11, 12) into the cavity (13, 14) allocated to it.

4. Dental model according to claim 2, characterised in that a latching pin (19) held in the supporting frame (8) serves for positioning the base body (1) into the demonstration positions, with two bore holes (17, 18) on the base body (1) that diametrically oppose one another on either side of the axis of rotation (7), which are assigned to said latching pin (19).

5. Dental model according to claim 4, characterised in that at least one part of the inner wall (20, 21, 22) of the supporting frame (8) has a curvature with a radius of curvature (R) which corresponds to the radius of the enveloping circle (23) that encloses the base body (1) in a plane running perpendicular to its axis of rotation (7).

6. Dental model according to claim 1, characterised in that the supporting frame (8) has, on its lower open side, an essentially ring-shaped, planar supporting surface.

7. Dental model according to claim 3, characterised in that a latching pin (19) held in the supporting frame (8) serves for positioning the base body (1) into the demonstration positions, with two bore holes (17, 18) on the base body (1) that diametrically oppose one another on either side of the axis of rotation (7), which are assigned to said latching pin (19).

8. Dental model according to claim 2, characterised in that at least one part of the inner wall (20, 21, 22) of the supporting frame (8) has a curvature with a radius of curvature (R) which corresponds to the radius of the enveloping circle (23) that encloses the base body (1) in a plane running perpendicular to its axis of rotation (7).

9. Dental model according to claim 3, characterised in that at least one part of the inner wall (20, 21, 22) of the supporting frame (8) has a curvature with a radius of curvature (R) which corresponds to the radius of the enveloping circle (23) that encloses the base body (1) in a plane running perpendicular to its axis of rotation (7).

10. Dental model according to claim 4, characterised in that at least one part of the inner wall (20, 21, 22) of the supporting frame (8) has a curvature with a radius of curvature (R) which corresponds to the radius of the enveloping circle (23) that encloses the base body (1) in a plane running perpendicular to its axis of rotation (7).

11. Dental model according to claim 2, characterised in that the supporting frame (8) has, on its lower open side, an essentially ring-shaped, planar supporting surface.

12. Dental model according to claim 3, characterised in that the supporting frame (8) has, on its lower open side, an essentially ring-shaped, planar supporting surface.

13. Dental model according to claim 4, characterised in that the supporting frame (8) has, on its lower open side, an essentially ring-shaped, planar supporting surface.

14. Dental model according to claim 5, characterised in that the supporting frame (8) has, on its lower open side, an essentially ring-shaped, planar supporting surface.
